(19) United States
(12) Patent Application Publication
(10) Pub. No.: US 2011/0157040 A1
(43) Pub. Date: Jun. 30, 2011

(54) TOUCHPANEL DEVICE, AND CONTROL METHOD AND PROGRAM FOR THE DEVICE

(75) Inventor: Hirokazu KASHIO, Chiba (JP)

(73) Assignee: SONY CORPORATION, Tokyo (JP)

(21) Appl. No.: 12/941,298

(22) Filed: Nov. 8, 2010

(30) Foreign Application Priority Data
Dec. 24, 2009 (JP) 2009-293147

(51) Int. Cl. G06F 3/041

(52) U.S. Cl. 345/173

(57) ABSTRACT

A touchpanel device includes an approach determining unit configured to determine whether an object has approached to a touchscreen; an area presuming unit, if it is determined that the object has approached to the touchscreen, configured to presume an area of contact on the touchscreen; and a display controller, based on a presumed area of contact, configured to control a size of a part of graphical user interface, the part being displayed on the touchscreen.

### BACKGROUND OF THE INVENTION

1. Field of the Invention

The invention relates generally to touchpanel devices and control methods for the devices. More particularly, the invention provides a touchpanel device loadable on compact equipments, and control method, program, and recording medium for the device for improving operability without degrading display capabilities.

2. Description of the Related Art

As the user interface of mobile devices such as mobile phones, personal digital assistant (PDA), and so forth, touchpanel devices have been adopted recently in increasing number. Since an input device and display device are integrated in the touchpanel, it follows by incorporating the touchpanel as user interface that the miniaturization of device size becomes feasible, various kinds of display modes and intuitive as well as legible operability can be realized by installing appropriate software.

Many touchpanels currently for use in mobile devices are those utilizing either the resistive film method or electrostatic capacitance method. By detecting and differentiating between two states on the touchpanels, contact state and non-contact, input triggers by the user to mobile devices are activated. This operation is made, for example, by touching with a fingertip a part (button and so forth) out of graphical user interface (GUI) built in a display frame of touchpanel.

With the increase of high-performance capabilities of mobile devices in recent years, the mobile devices have come to be utilized also in the area of information processing which has been previously implemented by personal computers and so forth. As a result, several requirements also arise such as, for example, displaying a software keyboard and implementing character inputs on small display screen of the mobile devices, and carrying out inputting steps through rather complicated GUI.

In such a case, because GUI parts may be smaller in size than a fingertip, input accuracy for the touchpanel may not be sufficient, in addition, when a fingertip is blurred and so on, that may result in an unintended selection or input error.

Regarding the selection of small GUI parts, for example, this type of inputting error has been sought to reduce previously by carrying out the selection by finding the part of GUI which is contacted at the moment of shifting from the state of contact to non-contact, thereby identifying this part as the one selected.

In addition, there is disclosed a method of providing a touchpanel on the surface of display, and detecting the relative spatial relation between a finger of user and display surface based on images taken with two cameras for use in approach detection provided in the vicinity of the touchpanel. In this method, if it is detected that the finger of user has approached to the display surface within a predetermined distance, the icon, to which the finger has approached, is configured to be displayed in a magnified manner (see, Japanese Unexamined Patent Application Publication No. 2006-236143, for example).

Thereby, the icon which is going to be selected by a user, is displayed in the magnified manner, this facilitates for the user to make the selection with more ease.

### SUMMARY OF THE INVENTION

With regard to the method of selection, however, a user may feel something uncomfortable with the previous method of making decision mentioned above concerning to small GUI parts, in which the selection is made as the part of GUI which is contacted at the moment of shifting from the state of contact to non-contact. That is, as far as user's psychology is concerned, it should be felt more natural if the selection is made at the moment of contact to the GUI part through the operation such as actually pushing button down.

In addition, although it may appear the selection of icon made easier when a GUI part displayed on the display surface is shown in a magnified manner, this may lead to the situation in which the information regarding others displayed on the same display surface may be obscured by hidden with the magnified icon. That is, it is preferable for GUI part be displayed small as long as none of difficulties is encountered in operativity.

Furthermore, with the recent improvement in capabilities of mobile devices, there is a trend for many functions to be integrated into each apparatus, such as a cellular-phone function, e-mail transceiver function, music playback function, picture image pick-up display function, and so forth, and the number of GUI parts displayed on the surface of display is also on the rise accordingly in recent years. It is increasingly important, therefore, to make the display on the panel surface more legible and to make the selection of icon with more ease.

The present invention is achieved in view of the background mentioned above and it is intended among others that the operability is improved of a touchpanel loadable onto compact equipments without degrading the display capabilities for the information.

According to one embodiment of the invention, a touchpanel device is provided which includes approach determining means for determining whether an object has approached to a touchscreen; area presuming means for presuming the area of contact on the touchscreen, if it is determined that the object has approached to the touchscreen; and display controller means, based on thus presumed area of contact, for controlling the size of a part of graphical user interface, which is displayed on the touchscreen.

It is configured for the touchpanel device to further include object number determining means, if it is determined that the object has approached to the touchscreen, for determining whether the number of the object is plural; and first display setting means, if it is determined that the number is plural, for setting a graphical user interface displayed on the touchscreen to a first graphical user interface, which is different from a default graphical user interface.

In addition, it is configured for the touchpanel device to further include second display setting means, if it is determined that the object has approached to the touchscreen, for setting the graphical user interface displayed on the touchscreen to a second graphical user interface, based on the kind of the object, which is different from the default graphical user interface.

In the touchpanel device, the approach determining means is configured to determine whether the object has approached to the touchscreen based on a plurality of images each taken covering from the side to the center of the touchscreen; and the area presuming means is configured to presume the area of contact based on three-dimensional shapes obtained by analyzing the plurality of images.

Still in addition, it is configured for the touchpanel device to further include selected part specifying means, if it is determined that the object has approached to the touchscreen, for specifying the part highly possible to be selected by being contacted with the object out of the graphical user interface and displaying the part in the mode different from that of other parts.

In the touchpanel device, the selected part specifying means is configured to identify the part highly possible to be selected by being contacted with the object out of the graphical user interface, based on the distance between the center of the region on the touchscreen corresponding to the presumed area of contact and the center of gravity point of respective part of the graphical user interface displayed on the touchscreen.

In addition, it is configured for the selected part specifying means in the touchpanel device to further include selection determining means for specifying the part highly possible to be selected out of the graphical user interface repeatedly at a predetermined time interval, and, if it is determined that the object has contacted to the region overlapping with the region of specified part of the graphical user interface, to establish the selection of the specified part.

In the touchpanel device, it is configured for the graphical user interface to be displayed on the touchscreen, if it is determined that the object has approached to the touchscreen.

According to another embodiment of the invention, a method for controlling a touchpanel is provided, which includes the steps of determining whether an object has approached to a touchscreen by approach determining means; presuming the area of contact on the touchscreen by area presuming means, if it is determined that the object has approached to the touchscreen; and controlling the size of a part of graphical user interface, based on thus presumed area of contact by display controller means, the part being displayed on the touchscreen.

According to still another embodiment of the invention, a computer program product is provided for use with a computer, the computer program product including a computer usable medium having computer readable program code means embodied in the medium for causing the steps of making the computer serve as a touchpanel device, the computer readable program code means including approach determining means for determining whether an object has approached to a touchscreen; area presuming means, if it is determined that the object has approached to the touchscreen, for presuming the area of contact on the touchscreen; and display controller means, based on thus presumed area of contact, for controlling the size of a part of graphical user interface, which is displayed on the touchscreen.

According to another embodiment of the invention, it is determined whether an object has approached to a touchscreen. If it is determined that the object has approached to the touchscreen, the area of contact area on the touchscreen is presumed and the size of a part of graphical user interface is controlled based on thus presumed area of contact, the part being displayed on the touchscreen.

According to this invention, therefore, the operability of a touchpanel, which is loadable onto compact equipments, can be improved without degrading display capabilities of the information.

### BRIEF DESCRIPTION OF THE DRAWINGS

FIG. 1 is a drawing illustrating the configuration of a touchpanel device according to an embodiment of the invention;

FIG. 2 includes a block diagram illustrating the internal configuration of the touchpanel device of FIG. 1;

FIG. 3 includes drawings illustrating the feature of taking several images from four directions with the imaging circuits of FIG. 2;

FIG. 4 includes drawings explaining the method for determining the abovementioned approach by the contact/approach determining section of FIG. 2;

FIG. 5 is a drawing illustrating the touchpanel operation with the touchpanel device according to an embodiment of the invention;

FIG. 6 is another drawing illustrating the touchpanel operation with the touchpanel device according to an embodiment of the invention;

FIG. 7 is still another drawing illustrating the touchpanel operation with the touchpanel device according to an embodiment of the invention;

FIG. 8 is a flowchart illustrating the contact detection processing implemented by the touchpanel device of the invention;

FIG. 9 is a drawing illustrating the situation when a finger has come to approach to the surface of touchscreen;

FIG. 10 is an enlarged partial drawing of a portion of the surface of touchscreen, in which the arrangement of parts of GUI and a contact area with the finger are shown;

FIG. 11 is another enlarged partial drawing of a portion of the surface of touchscreen, illustrating the center of the region of contact with the finger and the center of gravity of GUI;

FIG. 12 is a drawing illustrating the situation when the finger moves in the direction of the arrow away from the previous arrangement;

FIG. 13 is a drawing illustrating the feature with the finger moving approximately vertically downward to actually make contact to the surface of touchscreen;

FIG. 14 is another enlarged partial drawing of a portion of the surface of touchscreen, in which some of GUI parts of FIG. 13 are arranged for the selection on the touchscreen; and

FIG. 15 includes a block diagram illustrating the configuration of a personal computer according to an embodiment of the invention.

### DESCRIPTION OF THE PREFERRED EMBODIMENTS

Referring now to the drawings, preferable embodiments of the present invention will be detailed hereinbelow.

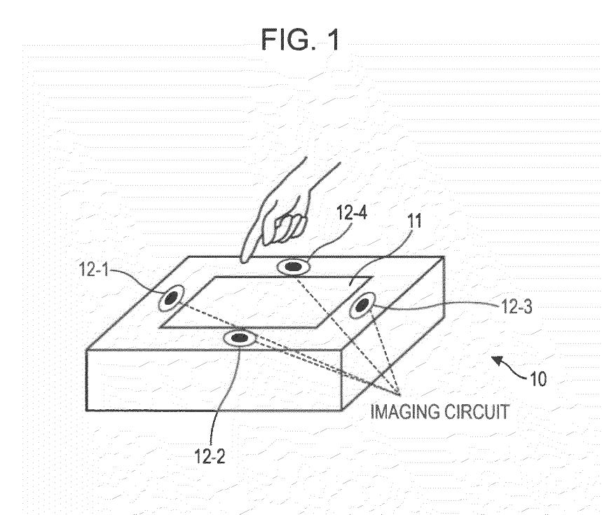

FIG. 1 is a drawing illustrating the configuration of a touchpanel device according to an embodiment of the invention.

The touchpanel device 10 shown in the drawing is configured to be able to detect the contact with a finger, stylus pen, and so forth onto the surface of touchpanel, and also detecting the approach by finger, stylus pen, and so forth to the surface of touchpanel. In addition, the touchpanel device 10 is also configured to detect that two or more fingers come to contact or approach to the touchpanel surface, and detect further the area of the portion of contact on the touchpanel by finger or stylus pen.

The touchpanel device 10 shown in FIG. 1 is formed including a touchscreen 11, and this touchscreen 11 is provided with GUI such as LCD for displaying images and a touchpanel for identifying the location of contact, for example.

In addition, each of imaging circuits 12-1 through 12-4 is provided on four sides of the square touchscreen 11. The imaging circuits 12-1 through 12-4 each include image sensors, and are configured to take, from four directions, the image of finger and stylus pen which approach to the touchscreen 11.

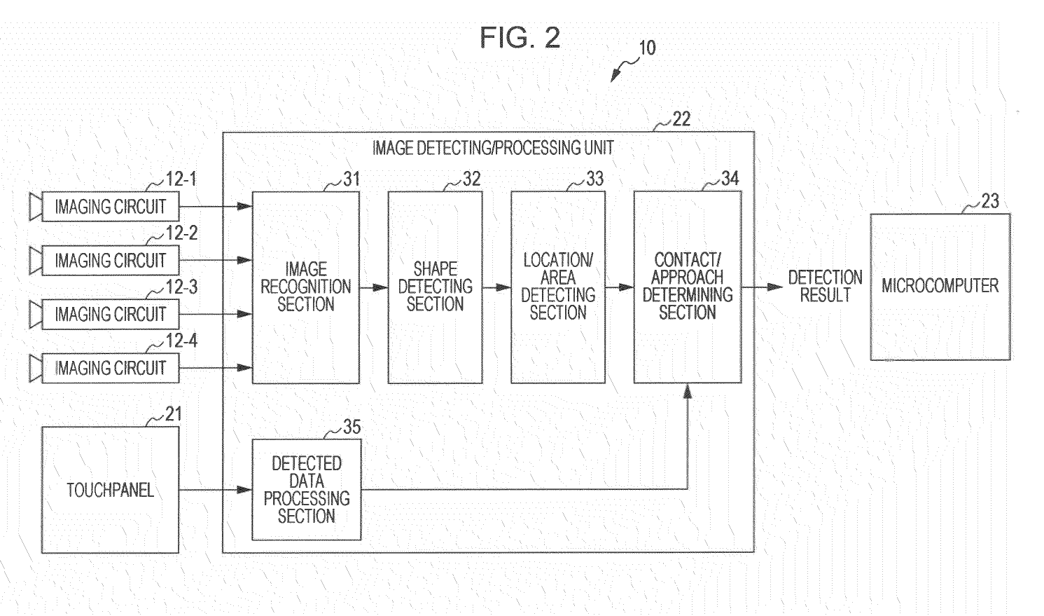

FIG. 2 includes a block diagram illustrating the internal configuration of the touchpanel device 10. As shown in the drawing, the touchpanel device 10 is provided with the imaging circuits 12-1 through 12-4, the touchpanel 21, and an image detecting/processing unit 22.

In addition, a microcomputer 23 and so forth, for example, are connected to image detecting/processing unit 22, and the processing corresponding to operation of the touchpanel device 10 is implemented with the microcomputer 23. For example, if the image detecting/processing unit 22 has detected that a finger or stylus pen made a contact to a predetermined portion of GUI displayed on the touchscreen, the processing necessary for implementing the function specifically assigned to the predetermined portion is carried out with the microcomputer 23.

As mentioned earlier, the imaging circuits 12-1 through 12-4 are configured to output the image data of finger and stylus pen, which are taken from respective directions, to the image detecting/processing unit 22.

The touchpanel 21 is configured to detect the presence and the location of the contact with the finger or stylus pen. As for the touchpanel 21, the resistive film method may be used, which utilize two sheets of the resistance films opposing with each other for detecting voltage outputs depending on the location of the operation, for example. In addition, other methods may alternatively be used such as the electrostatic capacitance method, for example, which is devised to obtain the location by measuring the change in capacitance between a conductor film and a fingertip or so forth.

Each of the image data outputted from the imaging circuits 12-1 through 12-4 is supplied to an image recognition section 31 of the image detecting/processing unit 22.

The image recognition section 31 is configured to make a discrimination between the objects approached to the touchscreen 11 based on the image data supplied as above. As an example, by comparing a first group of characteristic quantities extracted from the supplied image data with the information of a second group of characteristic quantities and so forth stored in advance, the image recognition section 31 makes the discrimination whether the object having approached presently to a touchscreen 11 is a finger, a stylus pen, or some other object.

If a recognition result is detected by the image recognition section 31, which is indicating that the finger or the stylus pen approached, each of the image data outputted from the imaging circuits 12-1 through 12-4 are respectively outputted to a shape detecting section 32 with the information on the recognition result.

The shape detecting section 32 is configured by analyzing the images taken from the four directions with the imaging circuits 12-1 through 12-4, to perform the computation for presuming three-dimensional shapes of finger or stylus pen. It may be noted since the shape of the stylus pen is alike almost every time, that the abovementioned computation presuming three-dimensional shapes may alternatively be carried out only when the recognition result detected by the image recognition section 31 indicates it is finger what presently approached.

The three-dimensional shape obtained as the result of computation by the shape detecting section 32 is supplied to a location/area detecting section 33 with the image data outputted from the imaging circuits 12-1 through 12-4.

The location/area detecting section 33 is configured by analyzing the images taken from the four directions with the imaging circuits 12-1 through 12-4, to perform the computation of the location of finger or stylus pen on the touchscreen 11. When a finger or a stylus pen is moved vertically downward, for example, the location/area detecting section 33 computes onto which location of the surface of touchscreen 11 is contacted, and the result is outputted in terms of x-y coordinate.

In addition, the location/area detecting section 33 is also configured by analyzing the images taken from the four directions with the imaging circuits 12-1 through 12-4, to perform the computation of the distance of the finger or stylus pen from the surface of the touchscreen 11. The location/area detecting section 33 outputs the thus computed distance in terms of z coordinate axis, for example.

Furthermore, the location/area detecting section 33 performs the computation for presuming the area of contact on the touchscreen 11 with the finger or stylus pen based on the three-dimensional shape obtained as the computation results by the shape detecting section 32. For example, when the three-dimensional shape of the finger or stylus pen is obtained approximately as cylindrical, the location/area detecting section 33 is configured to compute the contact area under the assumption that the area of basal plane of the cylinder is equal to the area of the contact abovementioned.

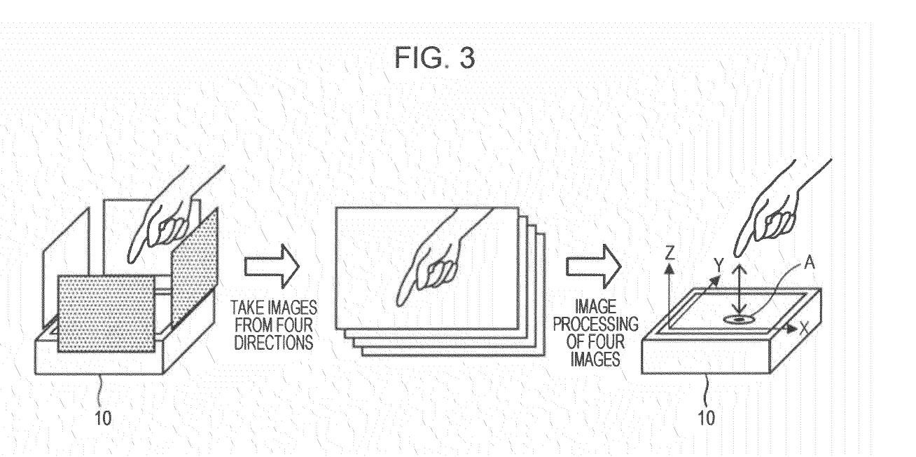

That is, as illustrated in FIG. 3, several images are taken at a predetermined time intervals from four directions with the imaging circuits 12-1 through 12-4, and the thus obtained four pieces of images are analyzed (subjected to image processing and so forth). As a result, the abovementioned values in terms of the x, y, and z axis coordinates at each time are obtained, and the value of area A is obtained as that of abovementioned area of contact as well.

Based on the results from the processing with a detected data processing section 35, which will be discussed below, and the abovementioned results obtained with location/area detecting section 33, a contact/approach determining section 34 is configured to determine whether the finger or stylus pen has made is either coming into contact with, or approaching to the touchscreen 11.

The detected data processing section 35 is configured to output the information concerning to which location of the surface of touchscreen 11 the finger or the stylus pen contacted, based on the information outputted from the touchpanel 21. The detected data processing section 35 outputs the contact location in terms of x-y coordinate, for example.

Therefore, it is configured that the information concerning to the results of the computation by the location/area detecting section 33 together with the determination results by the contact/approach determining section 34, are outputted as the detection results by the image detecting/processing unit 22. That is, as the detection results by the image detecting/processing unit 22, the information for distinguishing the kind of presently approaching object, namely, the information regarding which one of the finger and the stylus pen is approaching. Also, in the detection results by the image detecting/processing unit 22, there included is the information regarding which one of the finger and stylus pen is presently concerned, and how closely this object approached, or contacted, at which location of the surface of the touchscreen 11. Furthermore, also included are the results on the contact area on the touchscreen 11 with the finger or stylus pen.

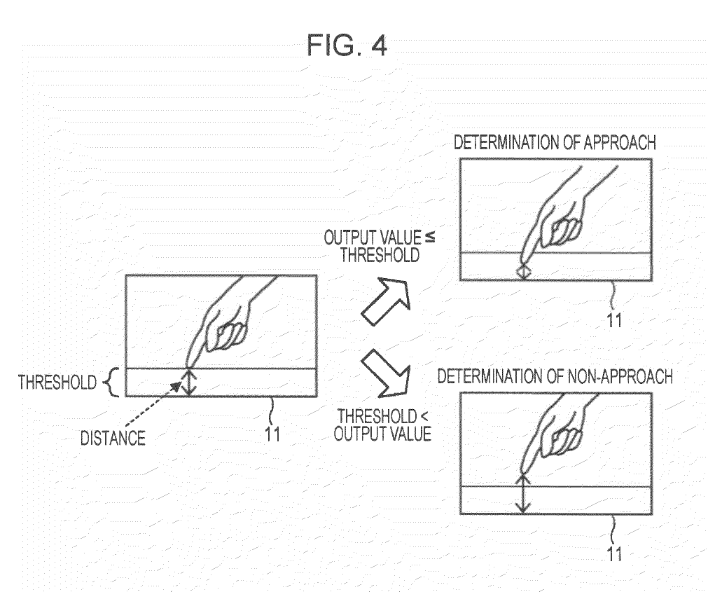

FIG. 4 includes drawings explaining the method for determining the abovementioned approach by the contact/approach determining section 34. This drawing illustrates the feature where the finger of a user operating the touchpanel device 10 is approaching to the surface of touchscreen 11 shown at the lower portion of the drawing. As shown in the drawing, a threshold value (as a predetermined distance of the fingertip and the surface of touchscreen 11) is set herein in advance for use in determining the approach. This threshold value is compared with several values in terms of z-axis coordinate outputted from the location/area detecting section 33 (distance from the surface of a touchscreen 11). It is therefore noted that the closer the finger comes to the touchscreen 11, the more the z-axis coordinate value, which is outputted from the location/area detecting section 33, approaches toward 0 (zero).

In addition, when an output value (z-axis coordinate value) below the threshold value is found, it follows that the finger is determined as in “contact” by the contact/approach determining section 34. By contrast, when an output value exceeds the threshold value, it follows that the finger is determined as in “non-contact” by the contact/approach determining section 34.

The touchpanel device 10 of the invention is also configured to display GUI on the touchscreen 11, when the approach of the finger or stylus pen is detected.

For example, when the distance between the finger and the touchscreen 11 is sufficiently large, GUI is not displayed on the touchscreen 11.

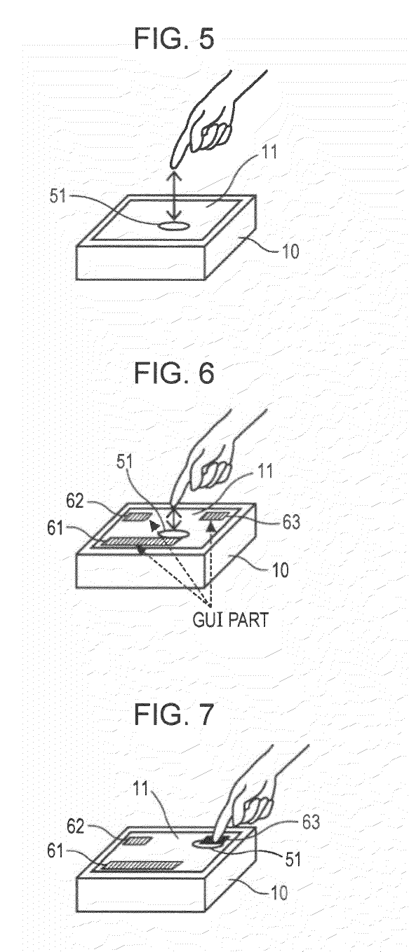

FIGS. 5 through 7 include drawings illustrating the touchpanel operation with the touchpanel device 10 according to an embodiment of the invention.

FIG. 5 is the illustration in case where the distance between the touchscreen 11 and the finger is sufficiently large. The area 51 shown as the circle in the drawing illustrates the region where contact with the finger and the touchscreen 11 is assumed.

In this case, the location/area detecting section 33 computes the distance of the finger or stylus pen from the surface of the touchscreen 11 by analyzing the images taken from the four directions with the imaging circuits 12-1 through 12-4, and subsequently outputs the thus computed distance in terms of z coordinate axis. Since the z-axis coordinate value exceeds the threshold value at present, it follows that the finger is determined as in non-contact by the contact/approach determining section 34.

The information concerning to this result of the determination is outputted to a microcomputer 23, for example, as one of the detection results by the image detecting/processing unit 22.

In FIG. 5, none of GUI is displayed on the touchscreen 11.

FIG. 6 is the illustration in case where a finger approaches to the touchscreen 11.

In this case, the location/area detecting section 33 computes the distance of the finger or stylus pen from the surface of the touchscreen 11 by analyzing the images taken from the four directions with the imaging circuits 12-1 through 12-4, and subsequently outputs the thus computed distance in terms of z coordinate axis. Since the z-axis coordinate value is found below the threshold value at present, it follows that the finger is determined as in contact by the contact/approach determining section 34.

Also in this case, by comparing a first group of characteristic quantities extracted from the image data, for example, supplied by the imaging circuits 12-1 through 12-4, with the information of a second group of characteristic quantities and so forth stored in advance, the image recognition section 31 determines that the object having approached presently to the touchscreen 11 is a finger.

Furthermore, the shape detecting section 32 performs the computation for presuming three-dimensional shapes of the finger by analyzing the images taken from the four directions with the imaging circuits 12-1 through 12-4. The location/area detecting section 33 performs the computation for presuming the area of contact with the finger on the touchscreen 11 based on the three-dimensional shape obtained as the computation results by the shape detecting section 32. The area of the region 51 is thereby obtained, for example.

In addition, the location/area detecting section 33 computes in terms of x-y coordinate, onto which location of the surface of touchscreen 11 is contacted when the finger is moved vertically downward, for example. Whereby, the coordinates of the center of the region 51 are computed.

The information concerning the abovementioned determination, discrimination, and computation is outputted the microcomputer 23 as the detection results by the image detecting/processing unit 22. The microcomputer 23 is configured to display GUI on LCD of the touchscreen 11. In FIG. 6, there displayed are several parts 61 through 63 of GUI on the touchscreen 11 upon detecting the approach of the finger.

Namely, it is configured with the touchpanel device 10 of the present invention that none of GUI is displayed on the touchscreen 11 until the approach of a finger (or stylus pen) is detected, while the GUI is displayed on the touchscreen 11 upon detecting the approach.

Incidentally, these parts 61 through 63 in this case are set as the parts which are to be displayed when the approach of the finger is detected, while if the approach is detected with a stylus pen, for example, there configured to be displayed are another set of parts of GUI. That is, the touchpanel device 10 of the invention is configured to be able to display different parts of GUI depending on the kind of the object with which the approach is detected.

In addition, the parts 61 through 63 are also made to be displayed in a magnified manner according to the contact area of finger on the touchscreen 11. For example, when the area of contact is below the threshold value, the parts 61 through 63 are displayed in the usual display size, while the parts 61 through 63 are displayed in a magnified manner when the area of contact exceeds the threshold value.

By displaying in this way, when a person with either a large hand or thick fingers operates the touchpanel device 10, the parts of GUI can be displayed in the magnified manner. On the other hand, when a person with either a small hand or thin fingers operates the touchpanel device 10, none of the GUI parts is displayed in the magnified manner.

While the example is shown herein above with GUI parts which are displayed in the magnified manner, it is needles to note that these GUI parts may be displayed alternatively in a reduced manner. In short, it is desirable the size of the GUI parts displayed on the touchscreen 11 be appropriately controlled if necessary.

In addition, while the example of FIG. 6 is described on the case where one finger approaches, it may be configured as well to display different parts of GUI in the case when two fingers simultaneously approach, for example.

As mentioned earlier, the location/area detecting section 33 computes the location of the surface of touchscreen 11 to which the finger makes contact when moved vertically downward, for example. It may be configured that the number of thus computed location is specified and the different parts of GUI are displayed according to the specified number (namely, number of the fingers), for example. Still in addition, there may also be configured the number of the fingers presently approach be specified based on the presumed three-dimensional shape obtained by the shape detecting section 32.

For example, it may be configured that default GUI is displayed when one finger is detected, and that another GUI is displayed when two fingers are detected. In similar manner, still another GUI may be displayed when three fingers are detected. By displaying in this way, it becomes feasible for a user to make intended parts of GUI be displayed out of a plurality of GUI through such a single operation as approaching with the finger.

Incidentally, when the finger and so forth, which approached once, is found presently to be separated from the surface of touchscreen 11, the display of the GUI is configured to be erased.

FIG. 7 illustrates the example when a finger contacts the touchscreen 11. In this example shown in the drawing, the finger makes the contact to the touchscreen 11 at the location where the part 63 of GUI is displayed. As a result, a region 51 and the part 63 are indicated in the drawing overlapping with each other.

In this case, based on the information outputted from the touchpanel 21, the detected data processing section 35 outputs the information indicating that the finger has contacted to the center of the region 51 on the surface of touchscreen 11, with the location of the contact in terms of x-y coordinates, for example. In addition, the determination results by the contact/approach determining section 34 are outputted as detection results by the image detecting/processing unit 22, and the processing for realizing the function assigned to the part 63, for example, is configured to be implemented by microcomputer 23.

That is, the selection of the part 63 is established in the state illustrated in FIG. 7.

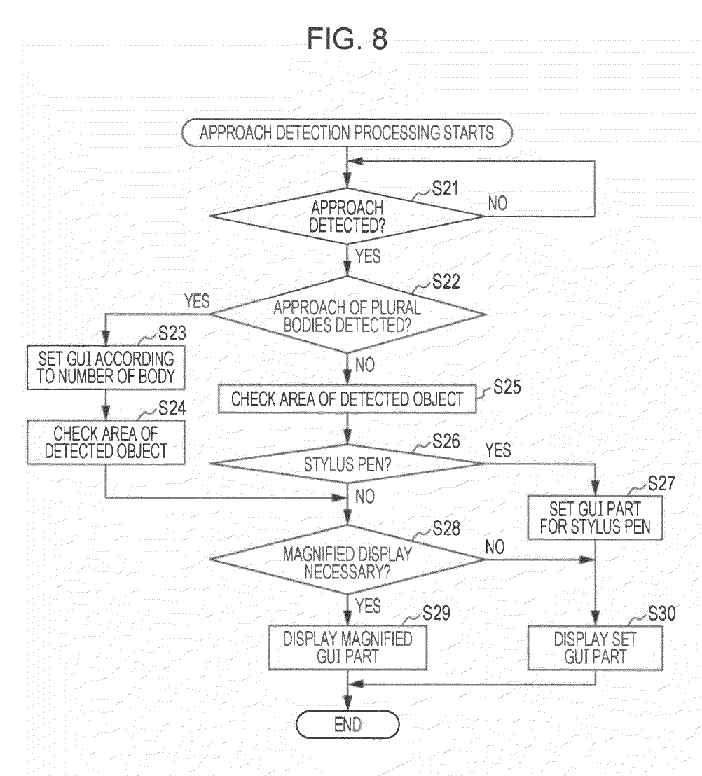

In the next place, with reference to the flowchart included in FIG. 8, an example of contact detection processing steps implemented by the touchpanel device 10 of the invention is described.

In step S21, the microcomputer 23 instructs to determine whether an approach of a finger or stylus pen is detected, and to stand by until the determination is made indicating that the approach of finger or stylus pen is detected. This determination is carried out based on the aforementioned determination results by the contact/approach detecting section 34.

If it is determined in step S21 that the approach of finger or stylus pen is detected, the process proceeds to step S22.

In step S22, the microcomputer 23 determines whether an approach of two or more objects is detected. This determination is carried out based on the number of the locations computed through the aforementioned computation of the contact location by the location/area detecting section 33, for example.

If it is determined in step S22 that the approach of two or more objects has been detected, the process proceeds to step S23. In this case, it is assumed that two fingers are detected. Incidentally, no assumption of detecting two or more stylus pens is made through the process.

In step S23, the microcomputer 23 instructs to set up GUI according to the number of the detected objects (finger). For example, in the case where it is assumed when one finger is detected that the image data, which are set to be displayed on LCD of touchscreen 11, are GUI parts of pattern A; the image data, which are set to be displayed when two fingers, are other GUI parts of pattern B. In addition, when three fingers are detected, there set as the image data to be displayed on LCD of touchscreen 11 are still another GUI of pattern C.

Incidentally, it is supposed that GUI of pattern A is set as default display data, for example.

In step S24, the microcomputer 23 instructs to check the area of the detected object (finger). As the area in this case, for example, there acquired is the value of the contact area on the touchscreen 11 of the finger, which is computed by the location/area detecting section 33 based on the three-dimensional shape obtained as the computation results by the shape detecting section 32.

On the other hand, if it is determined in step S22 that the approach of two or more objects is not detected, the process proceeds to step S25.

In Step S25, the microcomputer 23 instructs to check the area of the detected object. As the area in this case, for example, there acquired is the value of contact area on the touchscreen 11 of the finger or stylus pen, which is computed by the location/area detecting section 33 based on the three-dimensional shape obtained as the computation results by the shape detecting section 32.

Incidentally, this process may alternatively be configured not to carry out the computation of the contact area, when the approached object is found as the stylus pen.

In step S26, the microcomputer 23 determines whether the detected object is a stylus pen. The determination is carried out herein using the discrimination results based on the comparison of characteristic quantities by image recognition section 31, for example.

In step S26, if the detected object is determined as a stylus pen, process proceeds to step S27.

In step S27, the microcomputer 23 instructs to set up GUI for stylus pens. For example, the display data of GUI of pattern X are set as the image data to be displayed on LCD of touchscreen 11.

On the other hand, if it is determined either after step S27 or in step S26 that the detected object is not stylus pen, the process proceeds to step S28.

In step S28, the microcomputer 23 instructs to determine whether an image magnification is necessary for displaying GUI. It is determined herein whether the value of the contact area on the touchscreen 11 of the finger, which is obtained through the processing in step S24 or step S25, exceeds a threshold value, for example, and decided that the magnification is necessary when the value of the contact area exceeds the threshold value.

If it is determined in step S28 that the magnification is necessary, the process proceeds to step S29.

In step S29, the microcomputer 23 instructs to magnify each article of the GUI parts and display on LCD of touchscreen 11, based on the default display data of GUI or the display data of GUI set during the processing in step S23.

On the other hand, if it is determined either after step S27 or in step S28 that the magnification is not necessary, the process proceeds to step S30.

In step S30, the microcomputer 23 instructs to display each article of GUI parts on LCD of touchscreen 11, based on the default display data of GUI or the display data of GUI set during the processing in step S27.

Thereby, the approach detection processing is implemented.

Several difficulties have been encountered previously in operating the GUI parts displayed on touchscreen, since they are often too small for manipulation. Although the selection of icon may be improved by displaying the GUI parts on the surface of touchscreen in magnified manner, it may follow that the information on other parts which are displayed on the same display surface may be obscured by hidden with other icon.

In addition, it has been the recent trend with functional improvement of mobile devices to have many functions collectively loaded onto one apparatus such as cellular-phone function, e-mail transceiver function, music playback function, image capture/display function, and so forth, and the number of the GUI parts displayed on the display surface is on the increase as well. It is therefore become increasingly important to make displays on display device surface more legible, and to make icon selection easier.

By means of the touchpanel device 10 according to the invention, approach detection processing as noted just above can be implemented. Through the processing steps, when a person with either a large hand or thick fingers operates the touchpanel device 10, for example, the parts of GUI can be displayed in the magnified manner. On the other hand, when a person with either a small hand or thin fingers operates the touchpanel device 10, or the touchpanel device 10 is operated using a stylus pen, none of the GUI parts is displayed in the magnified manner.

Thereby, according to an embodiment of the invention, the operability can be improved without degrading the display capabilities of the information. In addition, since the touchpanel device 10 according to the invention is configured to display GUI on the touchscreen 11 upon approaching the finger and so forth, for example, the power consumption with the device can be reduced.

In the next place, there explained is the selection of the parts of GUI displayed on the touchscreen 11.

Based on the information outputted from the touchpanel 21 as mentioned above, the detected data processing section 35 outputs the information indicating that the finger and stylus pen have contacted to the center of the region 51 on the surface of touchscreen 11, together with the location of the contact in terms of x-y coordinates, for example. In addition, the determination results by the contact/approach determining section 34 are outputted as detection results by the image detecting/processing unit 22, and the processing for realizing the function assigned to the part 63, for example, is implemented by microcomputer 23.

Namely, it follows that the part of GUI, which is displayed at the location corresponding to the x-y coordinates for the contact location, is selected among the parts of GUI displayed on the touchscreen 11.

However, when the GUI parts displayed are small, for example, it is difficult to contact the location of the specific GUI part with a finger correctly, and this may lead to operation error with relative ease.

In order to deter such operation error, it is configured with the touchpanel device 10 of the invention to switch the mode of display of the parts of GUI and so forth according to the detection of approach of finger, stylus pen, and other. Thereby, it is arranged that the parts, which are highly possible to be selected by contacting with finger, are first presented to user, and that the definite selection of the part is made later when the finger, stylus pen, and other actually contact the surface of touchscreen 11.

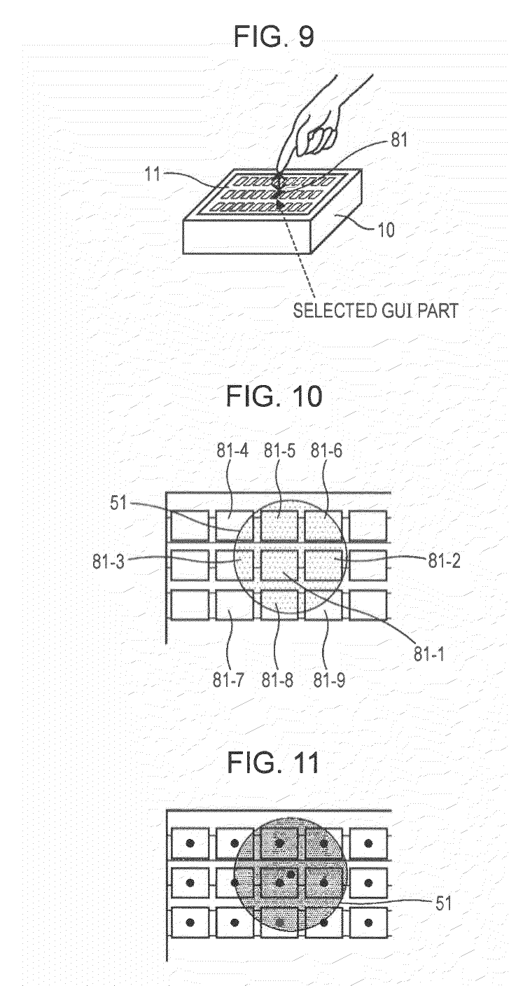

For example, when a finger has come to approach to the surface of touchscreen 11 as shown in FIG. 9, the part 81 is displayed in a color (for example, in red) different from other parts among the parts of GUI displayed on the screen.

When the finger approaches to the surface of touchscreen 11, as mentioned earlier, the location/area detecting section 33 computes the location on the surface of touchscreen 11 which the finger makes contact when moved vertically downward, for example. In addition, the location/area detecting section 33 also performs the computation for presuming the area of contact with the finger on the touch screen 11 based on the three-dimensional shape previously obtained as the computation results by the shape detecting section 32.

FIG. 10 is an enlarged partial drawing of a portion of the surface of touchscreen 11, in which the parts of GUI are arranged as shown in FIG. 10, for example. Referring to the drawing, each of the rectangles represents a part of GUI on the touchscreen 11, being systematically arranged horizontally and vertically in an array. It is assumed herein that the location, which is presumed be contacted with the finger approaching the touchscreen 11, is the region 51 designated with the circle in the drawing.

In the case of FIG. 10, for example, it is considered that the part highly possible to be selected by the contact with finger is the one placed at the location overlapping the region 51. In the present illustration, at least a part of the rectangles each corresponding to parts 81-1 through 81-9 are placed in the area overlapping the circle designating the region 51.

When a finger is made to approach to the surface of touchscreen 11, the microcomputer 23 instructs to specify the most likely part to be selected by contacting with finger, based on the location of contact on the surface of the touchscreen 11 and the area of contact on the touchscreen 11, both computed by the location/area detecting section 33. In this case, the most likely part to be selected is specified based on the distance between the center of circle represented by the region 51 of FIG. 10 and the center of gravity for the parts 81-1 through 81-9.

FIG. 11 is another enlarged partial drawing of a portion of the surface of touchscreen 11 in a similar manner to FIG. 10, to illustrate the center of the region 51 and the center of gravity of the GUI. In the drawing, the center of the region 51 is shown with the dark point shown at the center of the shadowed circle. In addition, the center of gravity point of respective part is shown with the dark point at the center of each rectangle. Incidentally, while each of the parts is assumed to be the identical rectangle in the present example, each may be alternatively different in shape and size, for example, and the center of gravity can be obtained in similar manner in this case as well.

Subsequently, the microcomputer 23 instructs to identify the part which has its center of gravity nearest in distance from the center of the region 51, and to specify this part as the most likely part to be selected. Namely, it follows that the part 81-1 of FIG. 10 is specified as the most likely part to be selected, and is displayed in red.

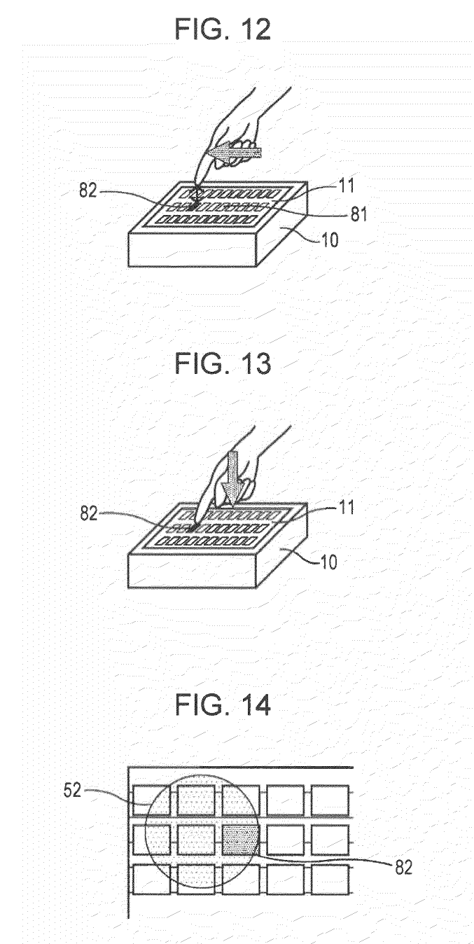

In addition, referring to FIG. 12, when the finger moves in the direction of the arrow shown in FIG. 12 away from the arrangement shown in FIG. 9, the part 81 previously displayed in red is turned back to the original display color and the part 82 is now displayed in red. Namely, when the finger is made to approach the surface of touchscreen 11, the microcomputer 23 instructs to implement the process repeatedly so as to specify the part, which has its center of gravity nearest in distance from the center of the region 51, as the most likely part to be selected, and to alter the display mode for the parts, accordingly.

For example, based on the information outputted as the detection results by the image detecting/processing unit 22, the microcomputer 23 instructs to determine whether the finger and so forth have contacted to the surface of touchscreen 11. If the determination is made indicating that the finger and so forth have contacted to the surface of touchscreen 11, the microcomputer 23 is configured to instruct repeatedly once every 0.5 second, for example, to implement the process of specifying the most likely part to be selected and altering the display mode for the parts accordingly.

It is assumed that the finger moves away from the arrangement shown in FIG. 12 to touch (make contact to) the location of the part 82 on the surface of touchscreen 11 as shown in FIG. 13. In FIG. 13, therefore, it is assumed leaving from the arrangement shown in FIG. 12 that the finger is moved approximately vertically downward to make contact to the surface of touchscreen 11.

The GUI parts are assumed this time to be arranged on the touchscreen 11, as shown in FIG. 14. In addition, the finger is assumed to have made contact actually to the region 52 on the surface of touchscreen 11 shown in the drawing. FIG. 14 is another enlarged partial drawing of a portion of the surface of touchscreen 11, in which each of the rectangles systematically arranged horizontally and vertically represents a part of GUI on the touchscreen 11.

In the arrangement of FIG. 14, although the part, which has its center of gravity nearest in distance from the center of the region 52, is not the part 82, the microcomputer 23 instructs to perform the processing for realizing the function assigned to the part 82 assuming that the part 82 has been selected. Namely, the selection of the part 82 is established.

When the finger is moved from the arrangement shown in FIG. 12 to that shown in FIG. 13, there are many situations where a fingertip comes to end as touching a location different from that intended. In such a case, if it is recognized that the part different from the one currently displayed in red has been selected, this may be taken by a user as the indication of low operability.

Therefore, with the touchpanel device 10 according to the embodiment of the invention, by disregarding slight movements made during the period after a finger and other approach the surface of touchscreen 11 until actually makes a contact, the selection of the part is determined as the part most likely be selected in the contact arrangement.

Incidentally, when no spatial overlap is found between the region 52 of FIG. 14 and the location of the part 82, it is configured so that the part other than part 82 is recognized as selected.

According to an embodiment of the invention, therefore, it is possible to reduce the occurrence of operation error. In addition, unlike the previous method in which the selection is determined as the GUI part which is contacted at the moment of shifting from contact state to non-contact, the selection in the present method is determined at the moment coming to contact to the GUI part by the operation of actually pushing button down, for example. As a result, while taking the reduction of the occurrence of operation error into consideration, it becomes feasible to provide a more natural operating environment as compared with the previous methods.

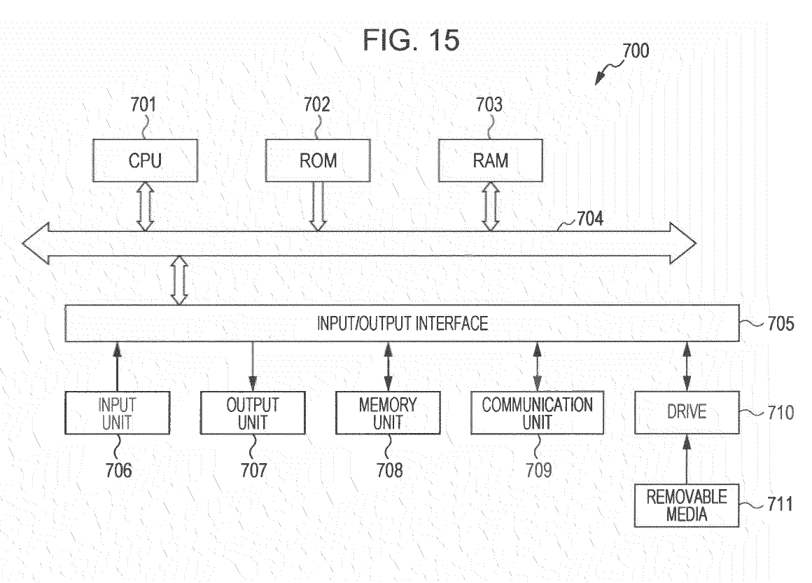

Incidentally, a series of processing mentioned above can be implemented by either hardware or software. When implementing the series of processing mentioned above by the software, the programs constituting the software are installed in the computer which is built into an exclusive hardware, by way of a network or a recording medium. In addition, by installing various kinds of programs, it is possible to be installed in a general-purpose personal computer 700, which is capable of performing various functions, such as the one shown in FIG. 15, by way of the network or recording medium.

Referring to FIG. 15, CPU (central processing unit) 701 is configured to implement various kinds of processing according to programs stored in ROM (read only memory) 702 or programs loaded onto RAM (random access memory) 703 from a memory unit 708. The RAM 703 is also loaded appropriately with the data necessary for the CPU 701 to implement the various processing.

CPU 701, ROM 702, and RAM 703 are interconnected by way of a bus 704. An input/output interface 705 is also connected to the bus 704.

Connected to the input/output interface 705 are an input unit 706 which includes a keyboard, mouse, and so forth, and an output unit 707 which includes a display incorporating LCD (liquid crystal display) and other, speaker, and so forth. In addition, also connected to the input/output interface 705 are a memory unit 708 which includes a hard disc and so forth, and a communication unit 709 which includes a modem, a network interface card such as LAN card and so on. The communication unit 709 performs the communication processing by way of the network including the Internet.

Also connected to the input/output interface 705 is a drive 710, where necessary, and the interface is appropriately provided with removable media 711 such as a magnetic disc, optical disc, magneto-optical disc, semiconductor memory, and so forth. In addition, the computer programs readout from the removable media are installed in the memory unit 708 when necessary.

When implementing the series of processing mentioned above by software, the programs constituting the software are installed from the network such as the Internet, and from the recording medium including the removable media 711 and so forth.

Incidentally, the recording media include not only (1) being respectively separated from the main body of apparatus shown in FIG. 15 and recorded with programs to be distributed in order to deliver the programs to user, magnetic discs (including floppy disc®), optical discs (including CD-ROM (compact disk—read only memory) and DVD (digital versatile disc)), magneto-optical discs (including MD (mini-disc)®) or removable media 711 including semiconductor memories and so forth, but also (2) being preinstalled in the main body of apparatus and recorded with programs to be delivered to user, ROM 702, hard discs included in the memory unit 708, or so forth.

It should be added that the series of processing steps mentioned earlier in this specification include not only the processing carried out in time sequence, but also those performed not necessarily in time sequence but in parallel or individually.

In addition, while the present invention has been described with reference to preferred embodiments, which are intended to be illustrative and not limiting, various modifications may be made without departing from the scope of the invention.

The present application contains subject matter related to that disclosed in Japanese Priority Patent Application JP 2009-293147 filed in the Japan Patent Office on Dec. 24, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touchpanel device, comprising:
approach determining means for determining whether an object has approached to a touchscreen;
area presuming means, if it is determined that the object has approached to the touchscreen, for presuming an area of contact on the touchscreen; and
display controller means, based on a presumed area of contact, for controlling a size of a part of graphical user interface, the part being displayed on the touchscreen.

2. The touchpanel device according to claim 1, further comprising:
object number determining means, if it is determined that the object has approached to the touchscreen, for determining whether a number of the object is plural; and
first display setting means, if it is determined that the number is plural, for setting a graphical user interface displayed on the touchscreen to a first graphical user interface, the first graphical user interface being different from a default graphical user interface.

3. The touchpanel device according to claim 2, further comprising:
second display setting means, if it is determined that the object has approached to the touchscreen, for setting the graphical user interface displayed on the touchscreen to a second graphical user interface based on a kind of the object, the second graphical user interface being different from default graphical user interface.

4. The touchpanel device according to claim 1, wherein
the approach determining means is configured to determine whether the object has approached to the touchscreen based on a plurality of images each taken covering from a side to a center of the touchscreen; and
the area presuming means is configured to presume the area of contact based on three-dimensional shapes obtained by analyzing the plurality of images.

5. The touchpanel device according to claim 4, further comprising:
selected part specifying means, if it is determined that the object has approached to the touchscreen, for specifying a part highly possible to be selected by being contacted with the object out of the graphical user interface and displaying the part in a mode different from that of other parts.

6. The touchpanel device according to claim 5, wherein
selected part specifying means is configured to identify the part highly possible to be selected by being contacted with the object out of the graphical user interface, based on a distance between a center of a region on the touchscreen corresponding to the presumed area of contact and a center of gravity point of respective part of the graphical user interface displayed on the touchscreen.

7. The touchpanel device according to claim 6, wherein
the selected part specifying means further comprises selection determining means for specifying a part highly possible to be selected out of the graphical user interface repeatedly at a predetermined time interval, and if it is determined that the object has contacted to a region overlapping with the region of a specified part of the graphical user interface, for establishing a selection of the specified part.

8. The touchpanel device according to claim 1, wherein,
if it is determined that the object has approached the touchscreen, the graphical user interface is displayed on the touchscreen.

9. A method for controlling a touchpanel, comprising the steps of:
determining whether an object has approached a touchscreen by approach determining means;
presuming an area of contact on the touchscreen by area presuming means, if it is determined that the object has approached to the touchscreen; and
controlling a size of a part of graphical user interface based on a presumed area of contact by display controller means, the part being displayed on the touchscreen.

10. A computer readable storage medium containing a computer program product for use with a computer, the computer program product including a computer usable medium having computer readable program code means embodied in the medium for causing the steps of making the computer serve as a touchpanel device,
the computer readable program code means comprising:
approach determining means for determining whether an object has approached to a touchscreen;
area presuming means, if it is determined that the object has approached to the touchscreen, for presuming an area of contact on the touchscreen; and
display controller means, based on thus presumed area of contact, for controlling a size of a part of graphical user interface, the part being displayed on the touchscreen.

11. A recording medium readable by a machine, tangibly embodying at least one program of instructions executable by the machine to perform a method of making a computer serve as a touchpanel device, the method comprising:
determining whether an object has approached to a touchscreen by approach determining means;
presuming an area of contact on the touchscreen by area presuming means, if it is determined that the object has approached to the touchscreen; and
controlling a size of a part of graphical user interface based on a presumed area of contact, the part being displayed on the touchscreen by display controller means.

12. A touchpanel device, comprising:
an approach determining unit configured to determine whether an object has approached to a touchscreen;
an area presuming unit, if it is determined that the object has approached to the touchscreen, configured to presume an area of contact on the touchscreen; and
a display controller, based on a presumed area of contact, configured to control a size of a part of graphical user interface, the part being displayed on the touchscreen.

13. A computer readable storage medium containing a computer program product for use with a computer, the computer program product including a computer usable medium having a computer readable program code system embodied in the medium for causing the steps of making the computer serve as a touchpanel device,
the computer readable program code system comprising:
an approach determining unit configured to determine whether an object has approached to a touchscreen;
an area presuming unit, if it is determined that the object has approached to the touchscreen, configured to presume an area of contact on the touchscreen; and
a display controller, based on a presumed area of contact, configured to control a size of a part of graphical user interface, the part being displayed on the touchscreen.

14. A recording medium readable by a machine, tangibly embodying at least one program of instructions executable by the machine to perform a method of making a computer serve as a touchpanel device, the method comprising:
determining whether an object has approached to a touchscreen by an approach determining unit;
presuming an area of contact on the touchscreen by an area presuming unit, if it is determined that the object has approached to the touchscreen; and
controlling a size of a part of graphical user interface based on a presumed area of contact, the part being displayed on the touchscreen by a display controller.
